(19) United States
(12) Patent Application Publication
(10) Pub. No.: US 2019/0318248 A1
(43) Pub. Date: Oct. 17, 2019

(54) AUTOMATED FEATURE GENERATION, SELECTION AND HYPERPARAMETER TUNING FROM STRUCTURED DATA FOR SUPERVISED LEARNING PROBLEMS

(71) Applicant: NEC Laboratories Europe GmbH, Heidelberg (DE)

(72) Inventors: Luis Moreira-Matias, Heidelberg (DE); Sourabh Sarvotham Parkala, Mannheim (DE); Jihed Khiari, Heidelberg (DE); Diego Andres Espinoza Silva, Rancagua (CL)

(21) Appl. No.: 16/011,651

(22) Filed: Jun. 19, 2018

Related U.S. Application Data
(60) Provisional application No. 62/657,002, filed on Apr. 13, 2018.

(51) Int. Cl. G06N 5/00; G06N 99/00

(52) U.S. Cl. CPC G06N 5/003; G06N 99/005

(57) ABSTRACT

Methods and systems for automating supervised learning tasks are provided. Feature generation in a feature space having a plurality of features using at least one predefined process for a plurality of data types is performed. A minimum set of relevant features are identified. The feature space is decreased using at least one filtering approach and the minimum set of relevant features. A Bayesian combinatorial optimization heuristic is devised to jointly identify a feature subset and a hyperparameter setting for a given query, a machine learning algorithm, and a dataset.

### CROSS-REFERENCE TO PRIOR APPLICATION

Priority is claimed to U.S. Provisional Patent Application No. 62/657,002, filed on Apr. 13, 2018, the entire disclosure of which is hereby incorporated by reference herein.

### FIELD

The present invention relates to a method and system for performing feature engineering, selection and hyperparameter tuning for a machine learning algorithm, dataset, and/or query.

### BACKGROUND

Machine learning is a growing field in computer science. Machine learning allows systems to perform tasks with data, without being explicitly programmed. However, designing a machine learning system can be time consuming for engineers. For example, it may be difficult to determine a combination between data representation and hyperparameter values. Data representation requires both feature engineering and feature selection. Hyperparameter values are parameters that configure a machine learning algorithm. Engineers attempt to achieve an optimal explanatory model with a given supervised learning algorithm on a given task. An optimal explanatory model provides the best trade-off between inductive bias and variance with minimum generalization error. Various supervised learning algorithms can be chosen, including, for example, random forests and support vector machines. Additionally, machine learning systems can operate on various tasks including, for example, regression to forecast sales volumes from a retail operator; classification to distinguish a spam of a non-spam electronic mail message; regression to predict future travel times in a transit system. Many other problems can be operated on using machine learning systems. Today, machine learning systems do not determine these various options in an automated fashion.

In some systems, the relationship between the processes is discarded after each time a system is configured. Therefore, the process must be restarted every time there is a change on either of the configuration axes (data representation and hyperparameter values).

Automated optimization is a non-trivial engineering problem due to high dimensionality of the meta-solution space which may include discrete and continuous spaces (e.g. different hyperparameters on a multilayer perceptron) and dependencies among different values.

### SUMMARY

Some embodiments provide a method for automating supervised learning tasks. The method includes performing feature generation in a feature space having a plurality of features using at least one predefined process for a plurality of data types. A minimum set of relevant features are identified. The feature space is decreased using at least one filtering approach and the minimum set of relevant features. A Bayesian combinatorial optimization heuristic is devised to jointly identify a feature subset and a hyperparameter setting for a given query, a machine learning algorithm, and a dataset.

Another embodiment provides a configuration system comprising one or more processors which, alone or in combination, are configured to provide for performance of a number of steps. The steps include performing feature generation in a feature space having a plurality of features using at least one predefined process for a plurality of data types. A minimum set of relevant features are identified. The feature space is decreased using at least one filtering approach and the minimum set of relevant features. A Bayesian combinatorial optimization heuristic is devised to jointly identify a feature subset and a hyperparameter setting for a given query, a machine learning algorithm, and a dataset.

### BRIEF DESCRIPTION OF THE SEVERAL VIEWS OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 illustrates a method for tuning a machine learning algorithm according to an embodiment;

FIG. 2 illustrates a method for implementing Bayesian alternate model selection from FIG. 1 according to an embodiment;

FIG. 3 illustrates automation of stock management using the system of FIG. 1 according to an embodiment;

FIG. 4 illustrates a real-time vehicle dispatching transit system using autonomous vehicles using the system of FIG. 1 according to an embodiment; and

FIG. 5 is a block diagram of a processing system according to an embodiment.

### DETAILED DESCRIPTION

A problem unique to computer systems and solved by embodiments of the present invention is the configuration of artificial intelligence (AI) implementations, such as machine learning systems. Embodiments of the invention reduce or remove the requirement for an engineer to configure machine learning systems by progressively automating machine learning (ML) applications. Many AI systems require extensive manual configuration by highly trained engineers and computer scientists. In some embodiments, the need of human supervision of the following ML-related tasks is removed or reduced: preprocessing, feature engineering/selection, hyperparameter tuning, post-processing, model selection, evaluation and interpretability.

Current systems, such as service-oriented architecture (SoA) on automated feature engineering include simple automation methods that are used independently and/or as part of a pipeline like one-hot-encoding, PCA or polynomial expansion. Typically, feature selection helps to reduce errors from excessive inductive variance of AI models. In these systems, hyperparameter tuning operates primarily as a bias component. Wrapper methods for feature selection may operate as optimization heuristics. These methods consecutively remove and/or add features from the selected feature subset. Each feature subset is evaluated by training an ML model and assessing its generalization error.

SoA on automated feature selection include both filter (e.g. Pearson Correlation) and Wrapper (e.g. Genetic algorithm, Recursive Feature Elimination) methods. Automated hyperparameter tuning comprises different methods such as grid search/random search or Bayesian optimization procedures (e.g. using gaussian processes). In Bayesian optimization heuristics, the decision about what point to evaluate next from an unknown loss function is biased by what will be its likely outcome.

Embodiments of the invention address issues in previous systems by automating machine learning applications. Preprocessing, feature engineering/selection, hyperparameter tuning, post-processing, model selection, evaluation and interpretability can be accomplished with no or minimal human intervention.

Embodiments include a method to automatically perform feature engineering, selection and hyperparameter tuning for a given tuple (dataset, ML algorithm, query). Some embodiments settle in a stepwise process that determines an algorithmic configuration that maximizes the bias-variance tradeoff of the resulting model. A component is the multi-criteria Bayesian optimization heuristic that alternatively tunes the feature space and the hyperparameter settings. Embodiments include, for example, automated stock management for retail and automated vehicle dispatching for mass transit systems.

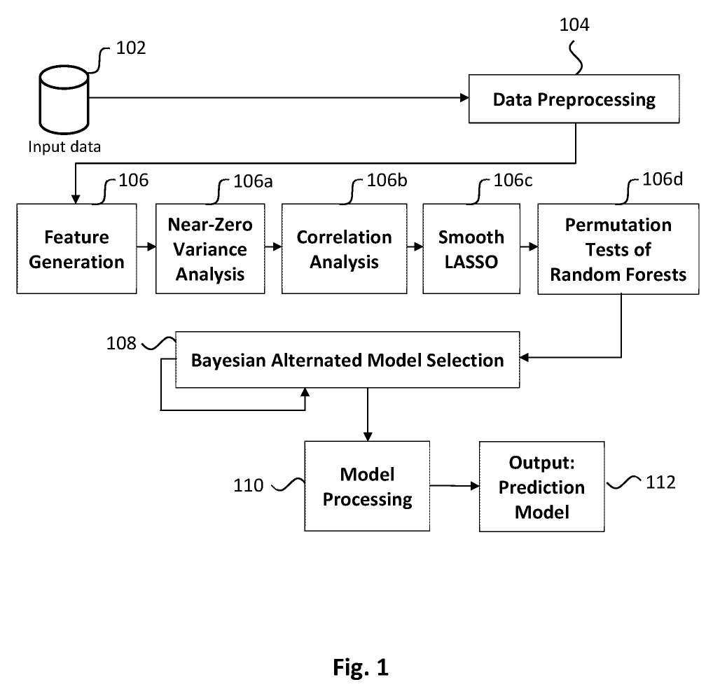

FIG. 1 illustrates a method for auto-tuning (AT) a machine learning algorithm according to an embodiment. Auto-tuning is a stepwise representation learning method which can be coupled with a supervised learning algorithm. Supervised learning algorithms include, for example, classification and regression algorithms. Every dataset may have its own explanatory model. For example, in a transit system, routes passing through small roads and the vehicle type used may have a large influence on the travel time experienced on that route. Consequently, one way to represent the variance in the input and feature space in order to model the joint distribution between the target and those explanatory variables may vary for each pair of dataset and machine learning algorithm.

Embodiments of the auto-tuning procedure include automated feature engineering techniques, supervised and unsupervised feature selection methods, and filters and wrappers. Filters include, for example, near zero variance, correlation analysis, lasso, and random forest techniques. Wrappers include, for example, Bayesian combinatorial optimization heuristics. These components balance the reduction of inductive bias error and the increase of variance error. In particular, auto-tuning encloses a wrapper method that follows a multi-criteria Bayesian optimization procedure. The procedure alternatively tunes hyperparameters and feature space. In some embodiments, these characteristics increase or maximize the predictive power of a supervised learning algorithm by providing a generalization error near its global optimum.

In FIG. 1, at step 104 data preprocessing occurs. The data is received from a data store 102 or another source such as a network. In this step, various procedures are applied to the data. For example, removal of missing data and feature normalization procedures are performed. At step 106, feature generation is performed. Feature generation includes the generation of derivate features in a feature space using predefined processes for each data type. For example, a timestamp may be decoupled into daily and hourly bins. The feature space is exploded using a randomized polynomial expansion.

There are various feature selection with filter-type approaches. For example, in the Near-Zero Variance approach 106a, features with a low amount of variance are removed. In the Correlation Analysis approach 106b, features highly correlated with others are removed. The Smooth LASSO approach 106c includes a linear regression method with an embedded feature selection mechanism. Embodiments find an optimal shrinkage hyperparameter and then use a less restrictive filter (i.e. 50% of the original one). This removes only less relevant or irrelevant features. The Permutation Tests of Random Forests approach trains a random forest model first with all the features. Then, it removes each feature individually in a singular trial, in order to compute the predictive power that a particular feature contributes by estimating the out-of-the-bag error of each tree/bag with and without the feature. Various approaches 106a-106d can be combined in different combinations or only one approach may be used in some embodiments.

At step 108, the Bayesian Alternate Model selection (BAMs) is performed. A relatively small change of the feature space, particularly on less relevant features, has a minimal effect on the relative position of the hyperparameter settings effects on the generalization error. Embodiments include an adaptation of this heuristic that may produce faster results with similar predictive power. This is referred to as Bayesian alternated model selection (BAMs).

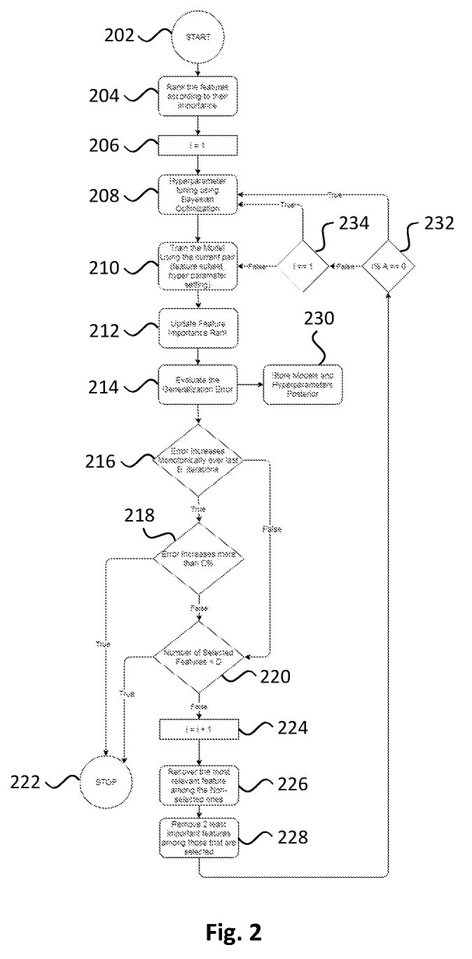

BAMs is a wrapper-type (i.e. algorithm agnostic) combinatorial Bayesian optimization heuristic to jointly explore two solution spaces: the optimal feature subset to cope with a given supervised learning algorithm and the optimal hyperparameter values for the same purpose. It provides low-effective dimensionality of the hyperparameter space to design a way of exploring the space by alternately updating different dimensions of the solution space. This notion is used to mathematically formulate a heuristic to devise priors on some of this dimension's distributions that allow it to speed-up this computationally intensive procedure considerably. This procedure is fully described below with respect to FIG. 2.

Step 110 is post-processing. In this step, the model is refined by assessing its sensibility to outliers. Using the optimal configuration defined in step 108, three additional models are trained with three simple procedures to handle different types of outliers: 1) remove them from the training set using tukey's rule; 2) perform a log-transformation of the output; and 3) perform both the steps 1 and 2). Finally, the generalization error of each of these 3 models is compared with the one obtained in step 108, and the best one is selected. At step 112, the prediction model is output.

FIG. 2 illustrates a method for implementing the Bayesian Alternate Model selection from FIG. 1 according to an embodiment. The process starts at step 202. At step 204, the features are ranked with respect to their importance using a strategy of interest. For example, absolute coefficients of linear regression may be used. At step 206, a counter, in this embodiment, i, is set to 1. At step 208, the hyperparameters are tuned using the total number of features using a limited number of iterations. For example, in one embodiment, 5 iterations are used.

At step 210, the model is trained, and at step 212, the importance rank of features is updated. The system stores the models and hyperparameters posterior at step 230. At step 214, the model is evaluated and its generalization error (e.g. using k-fold CV) is determined using the current set of hyperparameters. At step 216, the method determines whether the error has increased monotonically over the last set of iterations, B. If true, at step 218, the method determines whether the error has increased more than a set percentage, C. If it has, the system stops at 222. If the error has not increased more than the set percentage, than at step 220 the system determines if the number of selected features is less than a set number, D. If it is, the system stops at 222. If the number of features is not less than the set number, then the counter i is incremented at step 224. At step 226, the most relevant feature is recovered among the non-selected features. At step 228, the two least important features are removed, the available features are re-ranked, the model is trained, the generalization error is evaluated, and the most relevant feature is determined using the current set of hyperparameters.

At step 232, the system determines whether the set number of iterations has been reached. For example, the system may determine with the counter i has reached a threshold, such as 10. If the threshold has not been reached, the system returns to step 208 and the hyperparameters are tuned using the features currently selected using a limited number of iterations (e.g. 5). Note that this process is initialized using the posteriors obtained in step 210. The method continues until one of the stopping criteria is met (minimum number of features OR maximum error allowed). If step 232 determines that the set number of iterations has been reached, the systems determines if the counter is one at step 234. If the counter is one, the system proceeds to hyperparameter tuning at step 208. If the counter is not one, the system proceeds to train the model at step 210.

The steps 228 and 232 help to reduce inductive bias, while step 208 addresses inductive variance. By alternatively addressing different error components by performing changes on particular configuration/solution subspaces, a local minimum may be obtained. The feature space is pruned down using filter-based approaches for feature selection at steps 210, 212 and 214. Embodiments decrease the feature space to a minimum set of relevant features for the prediction task at hand. Embodiments leverage the feature importance coefficients obtained by SoA methods (e.g.: near zero variance, correlation analysis, lasso, random forest) to remove irrelevant features. Further, a Bayesian combinatorial optimization heuristic jointly finds the best feature subset and hyperparameter setting to cope with a given tuple (query, ML algorithm, dataset).

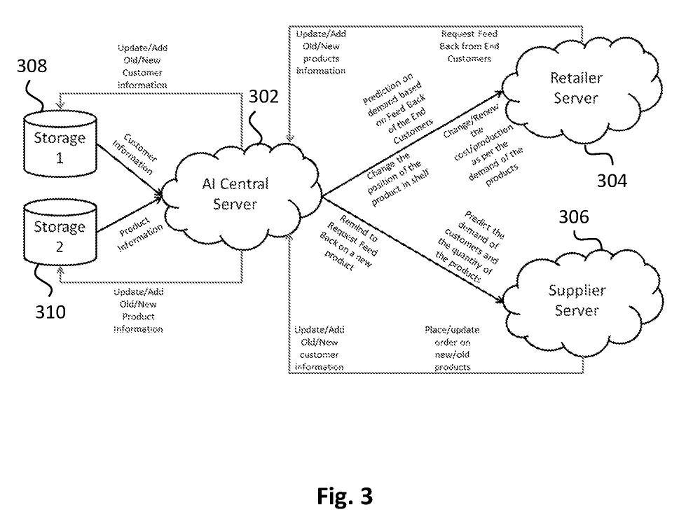

In one embodiment, the system can be used to automate stock management for a retail store. FIG. 3 illustrates automation of stock management using the system of FIG. 1 according to an embodiment. Stock management can be an issue for both large and small sized retail stores and operators. Different products have different characteristics which influence stocking decisions (e.g. size, weight, expiration date, etc.). These characteristics work as constraints in a decision problem. To find the optimal trade-off on the stock purchasing decisions depend on 4 major criteria: The space available to accumulate stock; The delivery time between order request and placement; The present/future items cost over time; and The present/future customer demand.

While the first two criteria can be computed by database queries, the latter ones must be predicted. This process is typically done either fully manually (using human domain experts) or is model-based. In a model-based system an explicit mathematical model is designed to model any of those characteristics in in relation to other factors and characteristics. Optimization heuristics are used to find the coefficients associated to all explanatory variables (e.g. least squares for linear regression problems). The design of the model requires a human expert.

Embodiments remove the human in-the-loop by fully automating the supply chain of a retail store. An AI-enabled central server 302 controls the flows of orders between retailers 304 and suppliers 306 based on the abovementioned factors. Advanced prediction models are used for delivery time and customer demand. The server 302 controls most of the supply chain pipeline, from the supply order to the shelf/ordering of the products in an automated logistics/stock management center. The central server receives information, from various storage systems. For example, storage 308 may provide information relating to customers. Storage 310 may provide product information. The server 302 may provide updated or new customer information back to storage 308. Likewise, the server 302 may provide updated or new product information back to storage 310.

Similarly, the AI central server 302 may receive requests for feedback from customers and updated or new product information form the retail server 304. The AI central server 302 may send information regarding the position of products on a shelf to the retail server 304. The AI central server 302 may also send changes and renewals for cost and product of products based on demand to the retail server 304. The AI central server 302 receives new and updated customer information from the supplier server 306. The AI central server 302 also receives order information for new and old products from the supplier server 306. The AI central server sends a reminder to request feedback information on products, including new products to the supplier server 306. The AI central server 302 also sends demand prediction of customers and product quantity to the supplier server 306.

The system also determines machine learning algorithms for the prediction models. While some approaches, such as SVR, may not require any parametric form for the relationship between target and explanatory variables, they still need to generate an adequate feature space/input representation to produce adequate results. This is known as feature engineering.

Manual Feature Engineering can be a time consuming process. However, in many domains it is only done once in a project. Notoriously, in retail, the dynamic nature of the business (with novel products and variants emerging in a daily basis) force this process to be regularly repeated—trading off the traditional human labor performed by domain experts by human labor performed by data science ones. Moreover, the changes on feature representation often require changes also on the hyperparameter setting.

Embodiments allow the removal or minimization of human-labor by automating the feature engineering, selection and hyperparameter tuning process. An illustrative possible system architecture for this embodiment is depicted in FIG. 3.

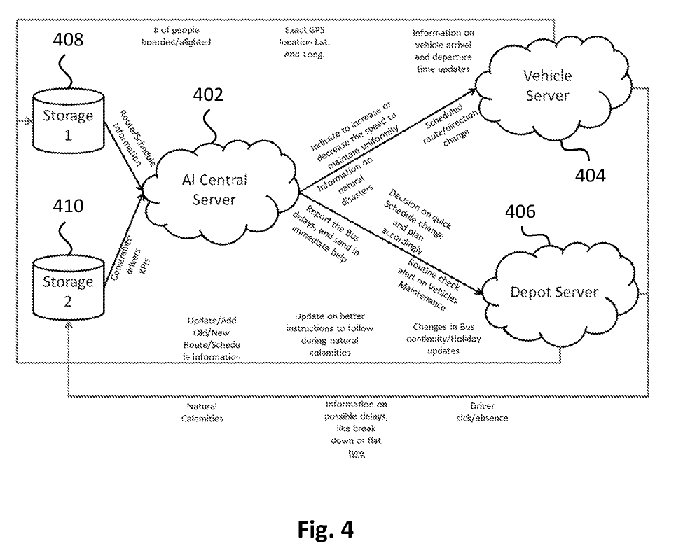

FIG. 4 illustrates a real-time vehicle dispatching transit system using autonomous vehicles using the system of FIG. 1 according to an embodiment. In one embodiment, many vehicles in mass transit lines will be driven autonomously. This may allow several tasks for operations. One task is the vehicle dispatching in depot. Vehicle dispatching plays a crucial role on high frequency lines. The dispatching strategy and their timing can set the thin threshold between a successful and an unsuccessful network operation. Dispatching decisions are usually taken by human experts either in depot or in an advanced control center. Traditionally, decisions like this are done to optimize operational key performance indicators (KPIs) such as Excess Waiting Time (EWT) and On-Time Adherence (EWT). These indicators fully depend on the vehicle's travel time. Consequently, human experts end up by adjusting their dispatching strategy with their own expectations experience-based about the travel time variability of each vehicle/route.

Embodiments automate the real-time vehicle dispatching on transit systems (with autonomous vehicles). The system on an AI central server 402 decides both the service and the departure time of each vehicle in the depot in real-time. The AI of the system settles on two components: A Travel Time Prediction (TTP) model learned with embodiments, such as those shown in FIG. 1, and rolling-horizon optimization procedure that is taking the decisions over the vehicles when fed with the predictions about how different planning scenarios (e.g. vehicle type A assigned to initiate service B on route C at timestamp D) will perform with respect to the operational KPIs in place.

AI central server 402 receives information from various storage systems and servers. For example, in one embodiment, AI central server 402 receives route and schedule information from storage 408. AI central server 402 receives constraints such as driver KPIs information from storage 408. AI central server 402 sends information such as natural disaster, speed change and schedule and routing information to vehicle server 404. Vehicle server 404 sends information on vehicle arrival and departure times, GPS locations and number of people on board to storage 408 and depot server 406. Vehicle server 404 also sends information on natural calamities, delay information and driver absence information to depot server 406 and storage 410.

Likewise, AI central server 402 sends information such as bus delays, help requests, schedule changes and check alerts for vehicle maintenance to depot server 406. Depot server 406 sends changes in transit continuity, instructions during natural and other service interruptions and new and updated schedule information to storage 410 and vehicle server 404. This embodiment minimizes the requirement for human-labor by automatizing the feature engineering, selection and hyperparameter tuning process. An illustrative possible system architecture for this embodiment is depicted in FIG. 4.

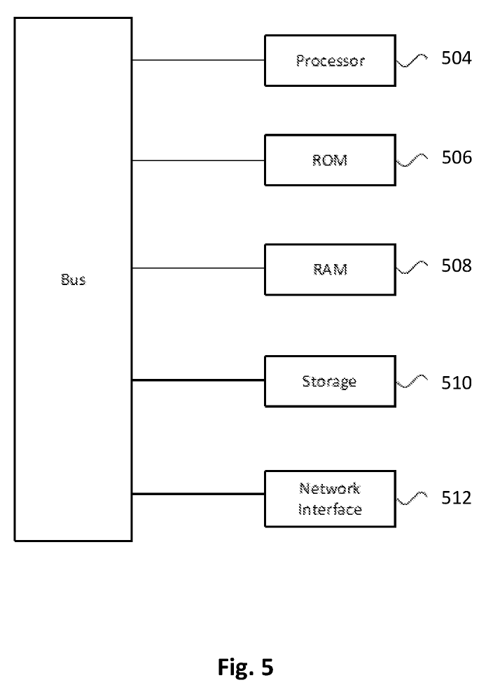

FIG. 5 is a block diagram of a processing system for implementing the methods and servers described above according to one embodiment. The processing system includes a processor 504, such as a central processing unit (CPU), executes computer executable instructions comprising embodiments of the system for performing the functions and methods described above. In embodiments, the computer executable instructions are locally stored and accessed from a non-transitory computer readable medium, such as storage 510, which may be a hard drive or flash drive. Read Only Memory (ROM) 506 includes computer executable instructions for initializing the processor 504, while the random-access memory (RAM) 508 is the main memory for loading and processing instructions executed by the processor 504. The network interface 512 may connect to a wired network or cellular network and to a local area network or wide area network, such as the internet.

All references, including publications, patent applications, and patents, cited herein are hereby incorporated by reference to the same extent as if each reference were individually and specifically indicated to be incorporated by reference and were set forth in its entirety herein.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for automating supervised learning tasks comprising:
performing feature generation in a feature space having a plurality of features using at least one predefined process for a plurality of data types;
identifying a minimum set of relevant features;
decreasing the feature space using at least one filtering approach and the minimum set of relevant features; and
devising a Bayesian combinatorial optimization heuristic to jointly identify a feature subset and a hyperparameter setting for a given query, a machine learning algorithm, and a dataset.

2. The method of claim 1 further comprising removing features using at least one of near zero variance, correlation analysis, lasso, and random forest.

3. The method of claim 1 wherein identifying a minimum set of relevant features further comprises removing two features from the feature space.

4. The method of claim 1 further comprising ranking features by importance.

5. The method of claim 1 further comprising evaluating a generalization error for the hyperparameter setting.

6. The method of claim 5 further comprising determining whether the generalization error has increased monotonically over a given number of iterations.

7. The method of claim 1 further comprising recovering a relevant feature from a set of non-selected features.

8. The method of claim 1 further comprising performing preprocessing on the dataset.

9. The method of claim 1 further comprising outputting the Bayesian combinatorial optimization heuristic.

10. The method of claim 1 further comprising refining the Bayesian combinatorial optimization heuristic by assessing it with the dataset.

11. A configuration system comprising one or more processors which, alone or in combination, are configured to provide for performance of the following steps:
performing feature generation in a feature space having a plurality of features using at least one predefined process for a plurality of data types;
identifying a minimum set of relevant features;
decreasing the feature space using at least one filtering approach and the minimum set of relevant features; and
devising a Bayesian combinatorial optimization heuristic to jointly identify a feature subset and a hyperparameter setting for a given query, a machine learning algorithm, and a dataset.

12. The system of claim 11 further comprising removing features using at least one of near zero variance, correlation analysis, lasso, and random forest.

13. The system of claim 11 wherein identifying a minimum set of relevant features further comprises removing two features from the feature space.

14. The system of claim 11 further comprising ranking features by importance.

15. The system of claim 11 further comprising evaluating a generalization error for the hyperparameter setting.
